(19) United States
(12) Patent Application Publication
(10) Pub. No.: US 2026/0341849 A1
(43) Pub. Date: Oct. 29, 2026

(54) SECONDARY BATTERY AND ITS ENCLOSURE MANUFACTURING APPARATUS

(71) Applicant: Samsung SDI Co., Ltd., Yongin-si (KR)

(72) Inventor: Jaemin Lim, Yongin-si (KR)

(73) Assignee: Samsung SDI Co., Ltd., Yongin-si (KR)

(21) Appl. No.: 19/332,353

(22) Filed: Sep. 18, 2025

(30) Foreign Application Priority Data
Apr. 24, 2025 (KR) 10-2025-0054045

(51) Int. Cl. H01M 50/105

(52) U.S. Cl. CPC H01M 50/105

(57) ABSTRACT

The present disclosure relates to an enclosure of a secondary battery and a method of manufacturing the same, and is directed to providing a technology for compliance with and maintenance of mechanical specifications and/or preventing deformation of an enclosure that may occur during a manufacturing process of a secondary battery and use of the manufactured secondary battery product. To this end, there is provided a secondary battery including: an electrode assembly; and an enclosure including a cell receiving portion in which the electrode assembly is received and a cover that seals the cell receiving portion, wherein heights of one end and the other end of the cell receiving portion of the enclosure are different from one another.

### CROSS-REFERENCE TO RELATED APPLICATIONS

This present application claims priority to and the benefit under 35 U.S.C. § 119(a)-(d) of Korean Patent Application No. 10-2025-0054045, filed on Apr. 24, 2025, in the Korean Intellectual Property Office, the entire disclosure of which is incorporated herein by reference.

### FIELD

Aspects of some embodiments of the present disclosure relate to a secondary battery, and more particularly, to an enclosure of a secondary battery and its manufacturing apparatus.

### BACKGROUND

Different from primary batteries that cannot be recharged, secondary batteries are batteries that can be charged and discharged. Typically, a secondary battery includes an electrode assembly, which is composed of positive and negative electrode plates and a separator.

The positive or negative electrode plates may be manufactured through a coating process in which an active material mixture is coated on one or both sides of a substrate, a rolling process in which the electrode plate coated with the mixture through the coating process is compressed and stretched to make the electrode plate thin and flat, a slitting process in which the electrode plate coated in multiple rows is cut in a longitudinal direction and separated into individual electrode plates, and a notching process in which each separated electrode plate is cut in a lateral direction, unnecessary portions are removed, and a tab is formed.

The electrode assembly is manufactured by assembling a plurality of manufactured electrode plates. The electrical connection between the electrode assembly and the external terminal may be made through a strip terminal welded to an electrode tab (or substrate tab) formed on a non-coated portion (uncoated portion) of the substrate of the electrode plate. The electrode assembly and the strip terminal are accommodated in the enclosure, and after electrolyte injection, the enclosure is finally sealed.

The above information disclosed in this Background section is for enhancement of understanding of the background of the present disclosure, and therefore, it may contain information that does not constitute a related (or prior) art.

### SUMMARY

The present disclosure is directed to providing a technology for compliance with and maintenance of mechanical specifications and/or preventing deformation of an enclosure that may occur during a manufacturing process of a secondary battery and use of the manufactured secondary battery product.

To solve the herein problems, according to features of the present disclosure, there is provided a secondary battery including: an electrode assembly; and an enclosure including a cell receiving portion in which the electrode assembly is received and a cover that seals the cell receiving portion, wherein heights of one end and the other end of the cell receiving portion of the enclosure are different from one another.

To solve the problems, according to features of the present disclosure, there is provided an apparatus for manufacturing an enclosure of a secondary battery including: a die on which an enclosure including a cell receiving portion, which includes a first sidewall and a second sidewall spaced apart from one another in a direction facing one another, a third sidewall and a fourth sidewall spaced apart from one another in a direction facing one another and respectively connecting both end portions of the first sidewall and the second sidewall, and a bottom portion connecting one surface of a closed loop formed by the first sidewall to the fourth sidewall, is mounted; and a punch pressing the enclosure seated in the die, wherein the die and the punch form the first sidewall and the second sidewall to have different heights.

Aspects and features of the present disclosure are not limited to those described herein, and other aspects and features not specifically mentioned herein will be clearly understood by those skilled in the art from the description of the present disclosure herein.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIGS. 1 and 2 are schematic views illustrating an electrode assembly of a secondary battery;

FIG. 3 is a schematic view illustrating a pouch-type secondary battery according to some embodiments of the present disclosure;

FIG. 4A is a cross-sectional view illustrating an enclosure of the conventional pouch-type secondary battery;

FIG. 4B is a schematic view illustrating a state in which an electrolyte is filled and removed from an enclosure of the conventional pouch-type secondary battery;

FIG. 5 is a cross-sectional view illustrating an enclosure according to embodiments of the present disclosure;

FIGS. 6 to 8 are cross-sectional views illustrating an enclosure according to embodiments of the present disclosure;

FIG. 9 is a cross-sectional view illustrating an apparatus for manufacturing an enclosure according to embodiments of the present disclosure;

FIGS. 10 to 12 are cross-sectional views illustrating an apparatus for manufacturing an enclosure according to embodiments of the present disclosure;

FIG. 13 is a view illustrating an example of a secondary battery pack; and

FIG. 14 is a view illustrating an example of a vehicle equipped with the secondary battery pack.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to one another, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

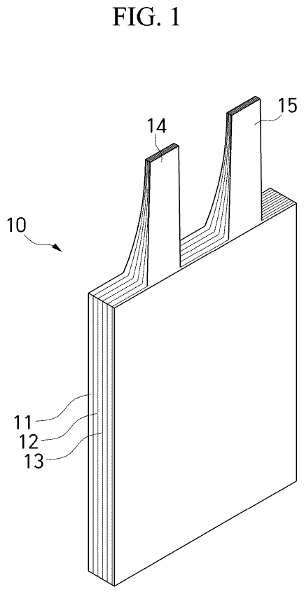

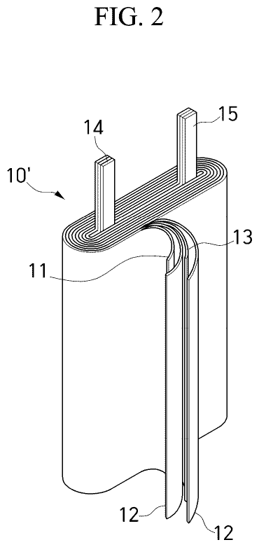

FIGS. 1 and 2 are schematic views illustrating an electrode assembly of a secondary battery.

Electrode assemblies 10 and 10′ may be manufactured by stacking individual sheets of a first electrode plate 11, a separator 12, and a second electrode plate 13 as illustrated in FIG. 1, or by winding each continuous body of a first electrode plate 11, a separator 12, and a second electrode plate 13 as illustrated in FIG. 2. However, in a different form from the electrode assemblies 10 and 10′ illustrated in FIGS. 1 and 2, there is also a so-called Z-stack type electrode assembly (not shown) in which a first electrode plate and a second electrode plate are inserted into each space on each side of the separator bent in a Z shape.

The first electrode plate 11, when serving as a negative electrode, may include a region on which an active material such as graphite or carbon is applied on a metal substrate such as copper, a copper alloy, nickel or a nickel alloy, and a region on which the active material is not applied. A first electrode tab 14 may be formed in the region on which the active material is not applied. Similarly, the second electrode plate 13, when serving as a positive electrode, may include a region on which an active material such as a lithium transition metal oxide is applied on a metal substrate such as aluminum or an aluminum alloy, and a region on which the active material is not applied. A second electrode tab 15 may be formed in the region on which the active material is not applied.

The separator 12 insulates the first electrode plate 11 and the second electrode plate 13 and allows lithium ion movement between the first electrode plate 11 and the second electrode plate 13. The separator 12 may be made of, for example, a polyethylene film, a polypropylene film, a polyethylene-polypropylene film, etc.

In some embodiments, the electrode assemblies 10 and 10′ are accommodated in an enclosure, such as a pouch, and may be filled with an electrolyte. In the case of a pouch-type secondary battery, the electrode assembly is accommodated in a pouch made of a flexible material.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤x≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); (Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; L¹ is Mn, Al, or a combination thereof.

A positive electrode for a secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ(0<x≤2), Si-based alloy, or a combination thereof.

The silicon-carbon composite may be a composite of silicon and amorphous carbon. According to embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99.5 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth) acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on one another.

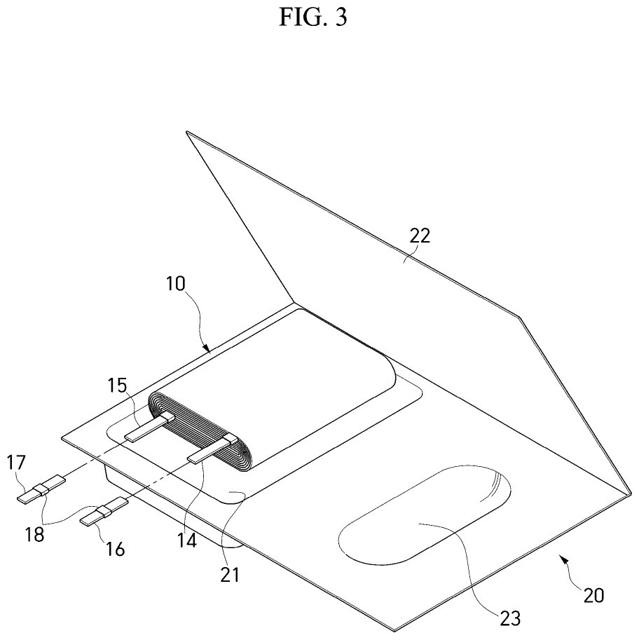

FIG. 3 is a schematic view illustrating a pouch-type secondary battery according to some embodiments of the present disclosure.

The pouch-type secondary battery may include an electrode assembly 10 and an enclosure 20, such as a pouch that accommodates the electrode assembly 10.

A first electrode tab 14 and a second electrode tab 15 of the electrode assembly 10, as illustrated in FIG. 3, may be electrically connected to an external first strip terminal 16 and second strip terminal 17 by welding, respectively. An insulating film 18 may be attached to each of the first strip terminal 16 and the second strip terminal 17 for insulation from the enclosure 20.

In the illustrated embodiment, the enclosure 20 includes a cell receiving portion 21 in which the electrode assembly is received, a gas collecting portion 23, and a cover 22 that covers an upper surface of the cell receiving portion 21 in which the electrode assembly 10 is received and seals outer edges of the cell receiving portion 21 and the gas collecting portion 23. After the electrode assembly 10 is placed in the cell receiving portion 21 and an electrolyte is injected, the outer edges of the cell receiving portion 21 and the cover 22 are sealed.

In this case, at least some region between the cell receiving portion 21 and the gas collecting portion 23 is not sealed, allowing the electrolyte and gas to pass through one another. In this state, a pressing process is performed to press the electrode assembly 10 so that the electrolyte is uniformly wetted between the electrode plates of the electrode assembly 10. During pressing, heating and/or charging/discharging of the electrode assembly 10 may be performed in parallel.

When the pressing process is completed, a degassing process may be performed to seal between the cell receiving portion 21 and the gas collecting portion 23 and cut the sealed portion to remove the gas collecting portion 23.

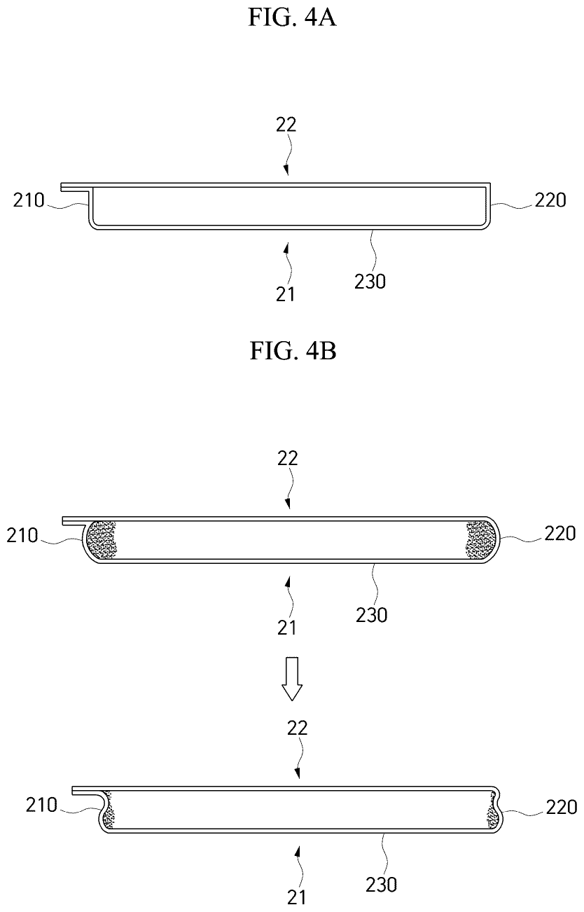

FIGS. 4A and 4B are provided to describe problems that may occur in an enclosure of the conventional pouch-type secondary battery.

Referring to FIG. 4A, a cell receiving portion 21 includes a first sidewall 210, a second sidewall 220, a third sidewall (not shown), a fourth sidewall (not shown), and a bottom portion 230. Also, the bottom portion 230 is substantially parallel to a cover 22 that covers the cell receiving portion 21. That is, heights of the first sidewall 210 and the second sidewall 220 or the third sidewall and the fourth sidewall are the same.

Meanwhile, as illustrated in FIG. 4B, in the degassing process, it is possible to reduce the electrolyte injected into the electrode assembly 10 (illustrated in FIG. 3) that is not absorbed into the separator 12 (illustrated in FIGS. 1 and 2), the first electrode plate 11 (illustrated in FIGS. 1 and 2), and the second electrode plate 13 (illustrated in FIGS. 1 and 2), and is freely floating inside the cell receiving portion 21, that is, the non-impregnated electrolyte.

In addition, as the electrolyte decreases, an area of the cell receiving portion 21 decreases.

In this case, as the area of the cell receiving portion 21 is reduced, the cell receiving portion 21 may be distorted, and a bulging phenomenon may occur on a part of a surface of the cell receiving portion 21.

To solve the herein-described problem, the cell receiving portion 21 of the present disclosure is configured such that one end and the other end, that is, the first sidewall and the second sidewall, have different heights. Here, the first sidewall is defined as a vertical wall on the side where the first electrode tab 14 and the second electrode tab 15, and the first strip terminal 16 and the second strip terminal 17 of the electrode assembly 10 illustrated in FIG. 3 are located. Also, the second sidewall is defined as a vertical wall opposite the first sidewall.

Hereinafter, for ease of description of the present disclosure, the following description will be based on the first sidewall 210 and the second sidewall 220, which are disposed spaced apart from one another.

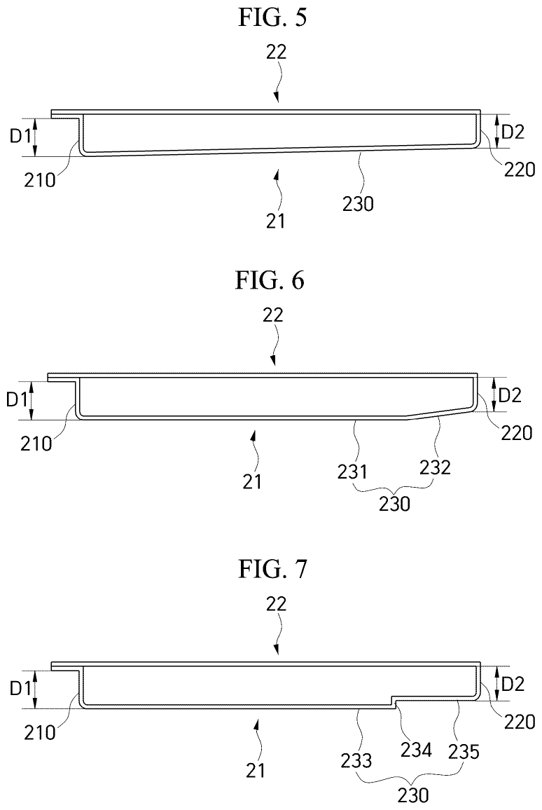

FIG. 5 is a cross-sectional view illustrating an enclosure according to embodiments of the present disclosure.

The first sidewall 210 and the second sidewall 220 forming the cell receiving portion 21 according to embodiments of the present disclosure are spaced apart from one another in a direction facing one another, and the third sidewall and the fourth sidewall are spaced apart from one another in a direction facing one another and respectively connect both ends of the first sidewall 210 and the second sidewall 220. The bottom portion 230 connects one surface of the closed loop formed by the first sidewall 210 to the fourth sidewall.

In addition, a length D1 of the first sidewall 210 is greater than a length D2 of the second sidewall 220. Also, the bottom portion 230 is inclined from the first sidewall 210 to the second sidewall 220. Here, the length D1 of the first sidewall 210 and the length D2 of the second sidewall 220 are defined as lengths in a direction substantially parallel to a thickness of the electrode assembly received in the cell receiving portion 21.

Specifically, the length D2 of the second sidewall 220 may be formed to a height of about 96 to 98% of the length D1 of the first sidewall 210.

Accordingly, in the degassing process, the embodiment of the present disclosure may minimize a bulging phenomenon that occurs on a part of a surface of the cell receiving portion 21 as the cell receiving portion 21 is distorted as much as the area of the cell receiving portion 21 is reduced, while reducing the non-impregnated electrolyte in the electrode assembly.

FIG. 6 is a cross-sectional view illustrating an enclosure according to embodiments of the present disclosure.

A bottom portion 230 according to embodiments of the present disclosure includes a first horizontal portion 231 and a first inclined portion 232.

The first horizontal portion 231 substantially horizontally extends from a first sidewall 210 toward a second sidewall 220, and the first inclined portion 232 is inclined from the first horizontal portion 231 to the second sidewall 220. Also, the first horizontal portion 231 is substantially parallel to the cover 22, and the first inclined portion 232 is inclined from the first horizontal portion 231 to the second sidewall 220, so that the length D1 of the first sidewall 210 is greater than the length D2 of the second sidewall 220.

Specifically, the first horizontal portion 231 may extend from about 50% to 90% of the total length from the first sidewall 210 to the second sidewall 220, and the first inclined portion 232 may extend from about 10% to 50% of the total length from the first sidewall 210 to the second sidewall 220. For example, when a length of the first horizontal portion 231 is about 90% of the total length from the first sidewall 210 to the second sidewall 220, a length of the first inclined portion 232 is about 10%.

Accordingly, the bottom portion 230 according to embodiments of the present disclosure may be formed with the first horizontal portion 231 and the first inclined portion 232, thereby minimizing a length of the inclined surface compared to embodiments.

FIG. 7 is a cross-sectional view illustrating an enclosure according to embodiments of the present disclosure.

A bottom portion 230 according to the embodiments includes a second horizontal portion 233, a first vertical portion 234, and a third horizontal portion 235.

The second horizontal portion 233 substantially horitzontally extends from a first sidewall 210 toward a second sidewall 220, the first vertical portion 234 substantially vertically extends from an end portion of the second horizontal portion 233 in an upper direction in which a cover 22 is disposed, and the third horizontal portion 235 substantially horitzontally extends from an end portion of the first vertical portion 234 to the second sidewall 220. Also, the second horizontal portion 233 and the third horizontal portion 235 are substantially parallel to the cover 22, and the third horizontal portion 235 extends from the end portion of the first vertical portion 234 extending upward from the second horizontal portion 233 and is connected to the second sidewall 220, so that a length D1 of the first sidewall 210 is greater than a length D2 of the second sidewall 220.

Specifically, the second horizontal portion 233 may extend from about 50% to 90% of the total length from the first sidewall 210 to the second sidewall 220, and the third horizontal portion 235 may extend from about 10% to 50% of the total length from the first sidewall 210 to the second sidewall 220. For example, when a length of the second horizontal portion 233 is about 90% of the total length from the first sidewall 210 to the second sidewall 220, a length of the third horizontal portion 235 is about 10%. Additionally, a height of the first vertical portion 234 is about 2 to 4% of a height of the first sidewall 210. That is, the first sidewall 210 is longer than the second sidewall 220.

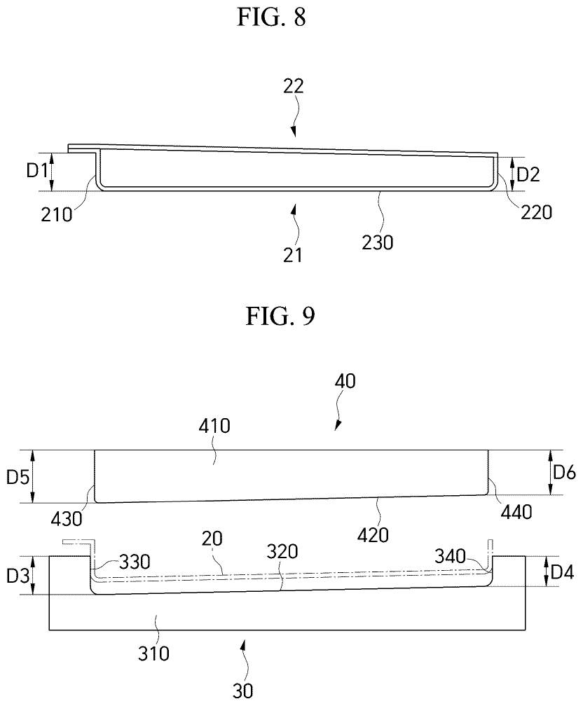

FIG. 8 is a cross-sectional view illustrating an enclosure according to embodiments of the present disclosure.

In embodiments of the present disclosure, a height of a first sidewall 210 is greater than a height of a second sidewall 220, and a bottom portion 230 may be horizontal. A length D2 of the second sidewall 220 is about 96 to 98% of a length D1 of the first sidewall 210, and a cover 22 is inclined from the first sidewall 210 to the second sidewall 220.

Accordingly, in embodiments of the present disclosure, the length D1 of the first sidewall 210 and the length D2 of the second sidewall 220 may be formed differently without an inclined surface of the bottom portion 230.

Hereinafter, an apparatus for manufacturing an enclosure of a secondary battery according to embodiments of the present disclosure is described in detail with reference to the attached drawings.

FIG. 9 is a cross-sectional view illustrating an apparatus for manufacturing an enclosure according to some embodiments of the present disclosure.

The enclosure manufacturing apparatus illustrated in FIG. 9 is an apparatus for manufacturing the enclosure illustrated in FIG. 5.

The apparatus for manufacturing a secondary battery enclosure according to embodiments of the present disclosure includes a die 30 and a punch 40 for manufacturing a secondary battery enclosure including a first sidewall 210 and a second sidewall 220 spaced apart from one another in a direction facing one another, a third sidewall and a fourth sidewall spaced apart from one another in a direction facing one another and respectively connecting both end portions of the first sidewall 210 and the second sidewall 220, and a bottom portion 230 connecting one surface of the closed loop formed by the first sidewall 210 to the fourth sidewall.

An enclosure material is seated on the die 30, and the punch 40 presses the enclosure seated on the die 30. In addition, the die 30 and the punch 40 form the first sidewall 210 and the second sidewall 220 to have different heights.

The die 30 includes a first body portion 310, a seating portion 320, a first guide portion 330, and a second guide portion 340. The first body portion 310 forms a body of the die 30, the seating portion 320 communicates with the outside through one surface of the first body portion 310, accommodates the enclosure, and comes into contact with the bottom portion 230, and the first guide portion 330 and the second guide portion 340 respectively extend upward from both end portions of the seating portion 320 and guide a receiving direction of the enclosure received in the seating portion 320. In addition, the seating portion 320 is inclined from the first guide portion 330 to the second guide portion 340.

Specifically, a height of the second guide portion 340 is about 96 to 98% of that of the first guide portion 330. Accordingly, the seating portion 320 may be formed in a shape that is inclined from the first guide portion 330 to the second guide portion 340.

The punch 40 includes a second body portion 410, a pressing portion 420, a first end portion 430, and a second end portion 440. The second body portion 410 forms a body of the punch 40, the pressing portion 420 is formed on a lower surface of the second body portion 410 and has a shape corresponding to the seating portion 320, and the first end portion 430 and the second end portion 440 are formed on both end portions of the second body portion 410.

The pressing portion 420 presses the bottom portion 230 accommodated in the seating portion 320. The first end portion 430 and the second end portion 440 respectively face the first guide portion 330 and the second guide portion 340 when the punch 40 presses the enclosure. Also, the pressing portion 420 is inclined from the first end portion 430 to the second end portion 440.

Specifically, a height of the second end portion 440 is about 96 to 98% of a height of the first end portion 430. Accordingly, the pressing portion 420 may be formed in a shape that is inclined from the first end portion 430 to the second end portion 440.

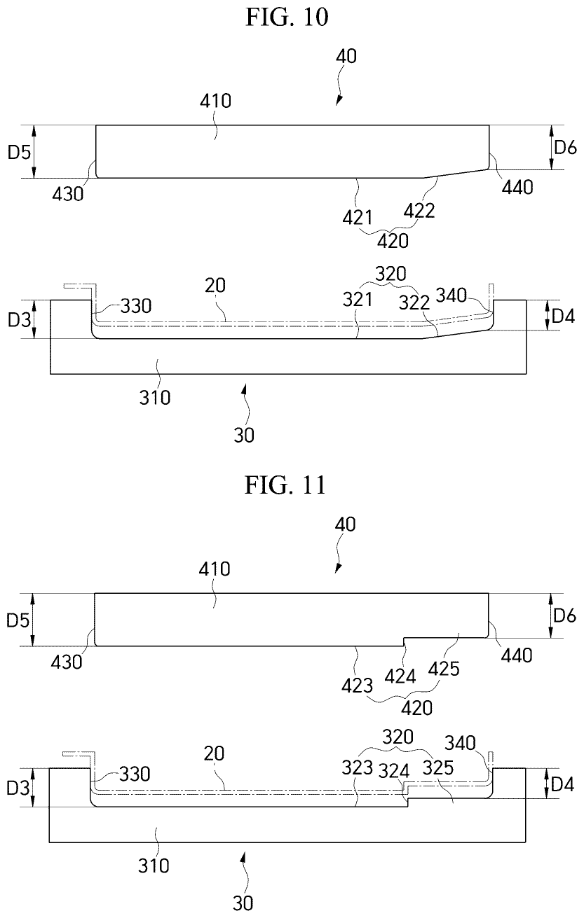

FIG. 10 is a cross-sectional view illustrating an apparatus for manufacturing an enclosure according to embodiments of the present disclosure.

The enclosure manufacturing apparatus illustrated in FIG. 10 is an apparatus for manufacturing the enclosure illustrated in FIG. 6.

A seating portion 320 according to embodiments of the present disclosure includes a fourth horizontal portion 321 and a second inclined portion 322.

The fourth horizontal portion 321 substantially horitzontally extends from a first guide portion 330 toward a second guide portion 340, and the second inclined portion 322 is inclined from the fourth horizontal portion 321 to the second guide portion 340. In addition, since the second inclined portion 322 is inclined from the fourth horizontal portion 321 to the second guide portion 340, a length D3 of the first guide portion 330 is greater than a length D4 of the second guide portion 340.

Specifically, the fourth horizontal portion 321 may extend from about 50% to 90% of the total length from the first guide portion 330 to the second guide portion 340, and the second inclined portion 322 may extend from about 10% to 50% of the total length from the first guide portion 330 to the second guide portion 340. For example, when a length of the fourth horizontal portion 321 is about 90% of the total length from the first guide portion 330 to the second guide portion 340, a length of the second inclined portion 322 is about 10%.

A pressing portion 420 according to embodiments of the present disclosure includes a first pressing portion 421 and a third inclined portion 422. The first pressing portion 421 substantially horitzontally extends from the first end portion 430 toward the second end portion 440, and the third inclined portion is inclined from the first pressing portion 421 to the second end portion 440.

Specifically, the first pressing portion 421 may extend from about 50% to 90% of the total length from the first end portion 430 to the second end portion 440, and the third inclined portion 422 may extend from about 10% to 50% of the total length from the first end portion 430 to the second end portion 440. For example, when a length of the first pressing portion 421 is about 90% of the total length from the first end portion 430 to the second end portion 440, a length of the third inclined portion 422 is about 10%. That is, the pressing portion 420 of the punch 40 is formed in a shape corresponding to the seating portion 320 of the die 30.

FIG. 11 is a cross-sectional view illustrating an apparatus for manufacturing an enclosure according to embodiments of the present disclosure.

The enclosure manufacturing apparatus illustrated in FIG. 11 is an apparatus for manufacturing the enclosure illustrated in FIG. 7.

A seating portion 320 according to the embodiments includes a fifth horizontal portion 323, a second vertical portion 324, and a sixth horizontal portion 325.

The fifth horizontal portion 323 substantially horitzontally extends from a first guide portion 330 toward a second guide portion 340, the second vertical portion 324 substantially vertically extends from an end portion of the fifth horizontal portion 323, and the sixth horizontal portion 325 substantially horitzontally extends from an end portion of the second vertical portion 324 to the second guide portion 340.

In addition, the fifth horizontal portion 323 and the sixth horizontal portion 325 are substantially parallel to the punch 40, and the sixth horizontal portion 325 extends from the end portion of the second vertical portion 324 that extends upward from the fifth horizontal portion 323 and is connected to the second guide portion 340, so that a length D3 of the first guide portion 330 is greater than a length D4 of the second guide portion 340.

Specifically, the fifth horizontal portion 323 may extend from about 50% to 90% of the total length from the first guide portion 330 to the second guide portion 340, and the sixth horizontal portion 325 may extend from about 10% to 50% of the total length from the first guide portion 330 to the second guide portion 340. For example, when a length of the fifth horizontal portion 323 is about 90% of the total length from the first guide portion 330 to the second guide portion 340, a length of the sixth horizontal portion 325 is about 10%. Additionally, a height of the second vertical portion 324 is about 2 to 4% of a height of the first guide portion 330. That is, the first guide portion 330 is longer than the second guide portion 340.

A pressing portion 420 according to the embodiments includes a second pressing portion 423, a third vertical portion 424, and a third pressing portion 425. The second pressing portion 423 substantially horitzontally extends from the first end portion 430 toward the second end portion 440, the third vertical portion 424 substantially vertically extends from an end portion of the second pressing portion 423, and the third pressing portion 425 substantially horitzontally extends from an end portion of the third vertical portion 424 to the second end portion 440.

Specifically, the second pressing portion 423 may extend from about 50% to 90% of the total length from the first end portion 430 to the second end portion 440, and the third pressing portion 425 may extend from about 10% to 50% of the total length from the first end portion 430 to the second end portion 440. For example, when a length of the second pressing portion 423 is about 90% of the total length from the first end portion 430 to the second end portion 440, a length of the third pressing portion 425 is about 10%. Additionally, a height of the third vertical portion 424 may be about 2 to 4% of the height of the first end portion 430. That is, the pressing portion 420 of the punch 40 is formed in a shape corresponding to the seating portion 320 of the die 30.

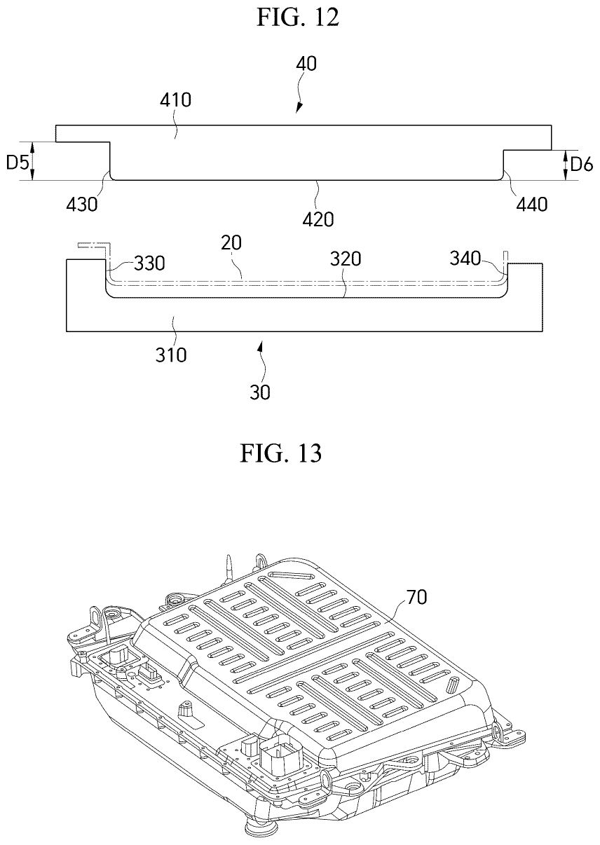

FIG. 12 is a cross-sectional view illustrating an apparatus for manufacturing an enclosure according to embodiments of the present disclosure.

The enclosure manufacturing apparatus illustrated in FIG. 12 is an apparatus for manufacturing the enclosure illustrated in FIG. 8.

According to the embodiments of the present disclosure, a length D5 of a first end portion 430 is greater than a length D6 of a second end portion 440, and a pressing portion 420 may be horizontal. Specifically, the length D6 of the second end portion 440 may be about 96 to 98% of the length D5 of the first end portion 430.

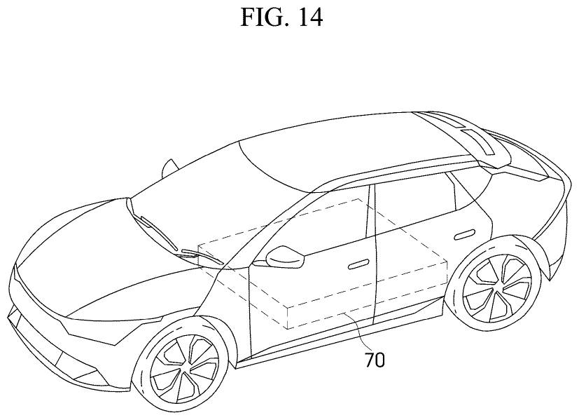

The secondary battery manufactured as described herein may be arranged and connected in a lateral direction and/or longitudinal direction to manufacture a secondary battery module. The arrangement of the secondary batteries may be designed in terms of arrangement direction and number to obtain the desired voltage and current specifications. A secondary battery pack 70 configured for application of the secondary battery module to an actual product (e.g., an automobile) is illustrated in FIG. 13. The secondary battery pack may be manufactured by embedding a plurality of secondary battery modules in a pack housing designed to be mounted on an actual product. The pack housing may include related elements such as fasteners and electrical connectors required for mounting on a product, bus bars for electrical connection of the secondary batteries, a cooling unit, and external terminals. As shown in FIG. 14, the secondary battery pack may be mounted on a vehicle. The vehicle may be, for example, an electric vehicle, a hybrid vehicle, or a plug-in hybrid vehicle.

According to an enclosure of a secondary battery and a method of manufacturing the same of the present disclosure, the difference in heights between a first sidewall and a second sidewall of a cell receiving portion provides the effects of minimizing a bulging phenomenon on a part of a surface of the cell receiving portion as the cell receiving portion is distorted due to a reduction in its area.

Although the present disclosure has been described herein with respect to embodiments thereof, the present disclosure is not limited thereto. Various modifications and variations can be made thereto by those skilled in the art within the spirit of the present disclosure as defined by the appended claims and their equivalents.

What is claimed is:

1. A secondary battery comprising:
an electrode assembly; and
an enclosure including a cell receiving portion in which the electrode assembly is received and a cover that seals the cell receiving portion,
wherein heights of one end and another end of the cell receiving portion of the enclosure are different from one another.

2. The secondary battery as claimed in claim 1, wherein the cell receiving portion of the enclosure comprises:
a first sidewall and a second sidewall spaced apart from one another in a direction facing one another;
a third sidewall and a fourth sidewall spaced apart from one another in a direction facing one another and respectively connecting both end portions of the first sidewall and the second sidewall; and
a bottom portion connecting one surface of a closed loop formed by the first sidewall to the fourth sidewall,
wherein a length of the first sidewall is greater than a length of the second sidewall.

3. The secondary battery as claimed in claim 2, wherein the bottom portion of the enclosure is inclined from the first sidewall to the second sidewall.

4. The secondary battery as claimed in claim 2, wherein the bottom portion of the enclosure comprises:
a first horizontal portion substantially horizontally extending from the first sidewall toward the second sidewall; and
a first inclined portion inclined from the first horizontal portion to the second sidewall.

5. The secondary battery as claimed in claim 4, wherein the first horizontal portion is substantially parallel to the cover.

6. The secondary battery as claimed in claim 2, wherein the bottom portion of the enclosure comprises:
a second horizontal portion substantially horizontally extending from the first sidewall toward the second sidewall;
a first vertical portion substantially vertically extending from an end portion of the second horizontal portion; and
a third horizontal portion substantially horizontally extending from an end portion of the first vertical portion toward the second sidewall.

7. The secondary battery as claimed in claim 6, wherein the length of the first sidewall is greater than the length of the second sidewall, and the bottom portion is substantially horitzontal.

8. The secondary battery as claimed in claim 6, wherein the cover is inclined from the first sidewall to the second sidewall.

9. An apparatus for manufacturing an enclosure of a secondary battery, comprising:
a die on which an enclosure including a cell receiving portion, which includes a first sidewall and a second sidewall spaced apart from one another in a direction facing one another, a third sidewall and a fourth sidewall spaced apart from one another in a direction facing one another and respectively connecting both end portions of the first sidewall and the second sidewall, and a bottom portion connecting one surface of a closed loop formed by the first sidewall to the fourth sidewall, is mounted; and
a punch pressing the enclosure seated in the die,
wherein the die and the punch form the first sidewall and the second sidewall to have different heights.

10. The apparatus as claimed in claim 9, wherein the die comprises:
a first body portion forming a body;
a seating portion having one surface of the first body portion communicating with the outside, receiving the enclosure, and coming into contact with the bottom portion; and
a first guide portion and a second guide portion respectively extending upward from both end portions of the seating portion and guiding a receiving direction of the enclosure received in the seating portion.

11. The apparatus as claimed in claim 10, wherein the seating portion is inclined from the first guide portion to the second guide portion.

12. The apparatus as claimed in claim 10, wherein the punch comprises:
a second body portion forming a body;
a pressing portion formed on a lower surface of the second body portion and having a shape corresponding to the seating portion; and
a first end portion and a second end portion formed at both end portions of the second body portion.

13. The apparatus as claimed in claim 12, wherein the pressing portion presses the bottom portion received in the seating portion.

14. The apparatus as claimed in claim 12, wherein the first end portion and the second end portion respectively face the first guide portion and the second guide portion when the punch presses the enclosure.

15. The apparatus as claimed in claim 14, wherein the pressing portion is inclined from the first end portion to the second end portion

16. The apparatus as claimed in claim 14, wherein the seating portion comprises:
a fourth horizontal portion substantially horizontally extending from the first guide portion toward the second guide portion; and
a second inclined portion inclined from the fourth horizontal portion to the second guide portion.

17. The apparatus as claimed in claim 16, wherein the pressing portion comprises:
a first pressing portion substantially horizontally extending from the first end portion toward the second end portion; and
a third inclined portion inclined from the first pressing portion to the second end portion.

18. The apparatus as claimed in claim 14, wherein the seating portion comprises:
a fifth horizontal portion substantially horizontally extending from the first guide portion toward the second guide portion;
a second vertical portion substantially vertically extending from an end portion of the fifth horizontal portion; and
a sixth horizontal portion substantially horizontally extending from an end portion of the second vertical portion toward the second guide portion.

19. The apparatus as claimed in claim 14, wherein the pressing portion comprises:
a second pressing portion substantially horizontally extending from the first end portion toward the second end portion;
a third vertical portion substantially vertically extending from an end portion of the second pressing portion; and
a third pressing portion substantially horizontally extending from an end portion of the third vertical portion toward the second end portion.

20. The apparatus as claimed in claim 19, wherein a length of the first end portion is greater than a length of the second end portion, and the pressing portion is substantially horizontal.
